(19) United States
(12) Patent Application Publication
(10) Pub. No.: US 2003/0095348 A1
(43) Pub. Date: May 22, 2003

(54) Vehicle wide-angle rearview mirror frame with storage box

(76) Inventor: Ying-Tu Kuo, Taoyuan Hsien (TW)

Correspondence Address: DOUGHERTY & TROXELL, SUITE 1404, 5205 LEESBURG PIKE, FALLS CHURCH, VA, 22041, US

(21) Appl. No.: 09/989,041

(22) Filed: Nov. 21, 2001

(51) Int. Cl. G02B 7/182

(52) U.S. Cl. 359/879; 359/871; 359/881

(57) ABSTRACT

A vehicle wide-angle rearview mirror frame has a storage box pivotally connected at a lower front edge to a lower rear edge of the rearview mirror frame, so that the storage box could be opened or closed by turning the rearview mirror frame away from or toward a front opening of the storage box. The storage box is then clamped onto a mounting plate of the rearview mirror frame of the vehicle. Miscellaneous items may be conveniently positioned in the storage box behind the wide-angle rearview mirror frame for easy access of these items without affecting the original function of the rearview mirror.

### BACKGROUND OF THE INVENTION

The quickly developing industrial technologies continuously upgrade people's living standards. People demand commercial products to have not only high quality but also versatile functions. In other words, consumers want to buy various products at economical prices while the products have added values due to their novelty, uniqueness, and new styles. A vehicle wide-angle rearview mirror frame would be much more useful and welcomed if it is designed to not only support a rearview mirror but also conveniently hold many miscellaneous items.

### SUMMARY OF THE INVENTION

A primary object of the present invention is to provide an improved vehicle wide-angle rearview mirror frame having a storage box pivotally connected to a rear side thereof for conveniently holding miscellaneous things in the storage box for easy access of these things during driving. The storage box is provided at an upper rear edge with elastic clamping claws for firmly clamping it to a mounting plate of the rearview mirror frame. Two hinge joints are provided between a lower front edge of the storage box and a lower rear edge of the rearview mirror frame for the latter to openably close a front opening of the storage box. And, a box fastener formed from a fastening stud fixedly mounted at a middle point of an upper rear edge of the rearview mirror frame and a socket side fixedly mounted at a middle point of an upper front edge of the front opening of the storage box for detachably engaging with the fastening stud allows the storage box to be openably locked to the rear side of the wide-angle rearview mirror frame.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of the present invention;

FIG. 2 is an enlarged exploded perspective view of a hinge joint connecting the storage box to the wide-angle rearview mirror frame of the present invention;

FIG. 3 is an enlarged exploded perspective view of a socket side of a box fastener for closing the storage box to the wide-angle rearview mirror frame of the present invention;

FIG. 4 is an assembled perspective view of the present invention with the storage box in an opened state;

FIG. 5 is an assembled view of FIG. 2;

FIG. 6 is an enlarged perspective view of the box fastener for the present invention with a fastening stud thereof disengaged from the socket side of the box fastener;

FIG. 7 is an assembled perspective view of the present invention with the storage box in a closed state; and

FIG. 8 is a perspective view showing the present invention is mounted on a mounting plate of the wide-angle rearview mirror frame.

### DETAILED DESCRIPTION OF THE PREFERRED EMBODIMENTS

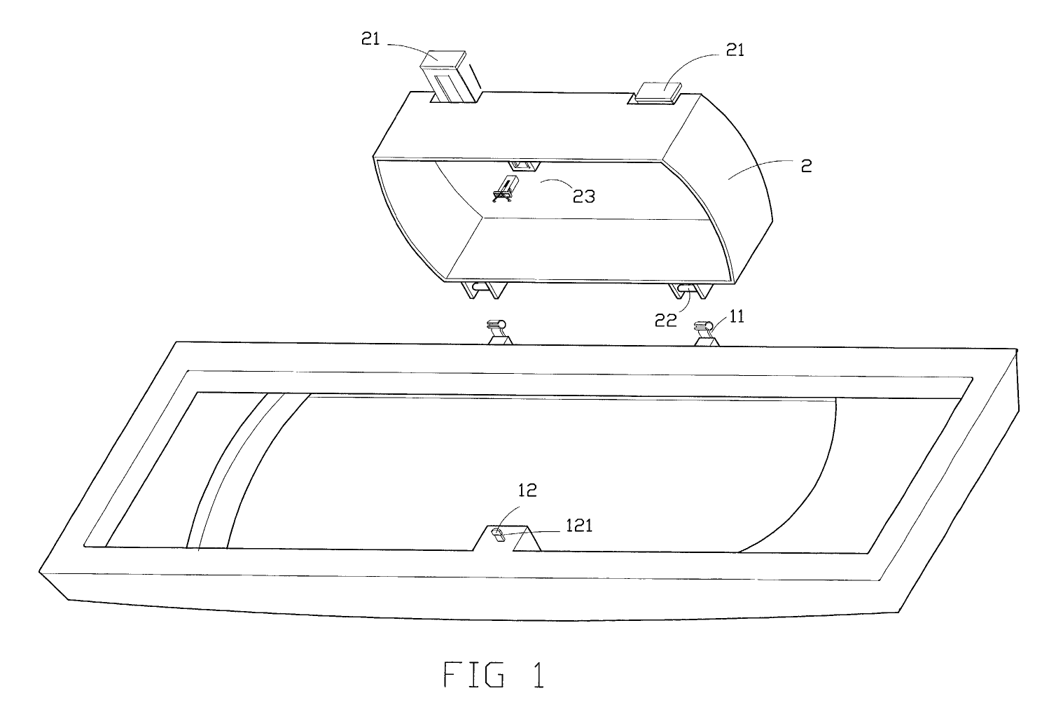

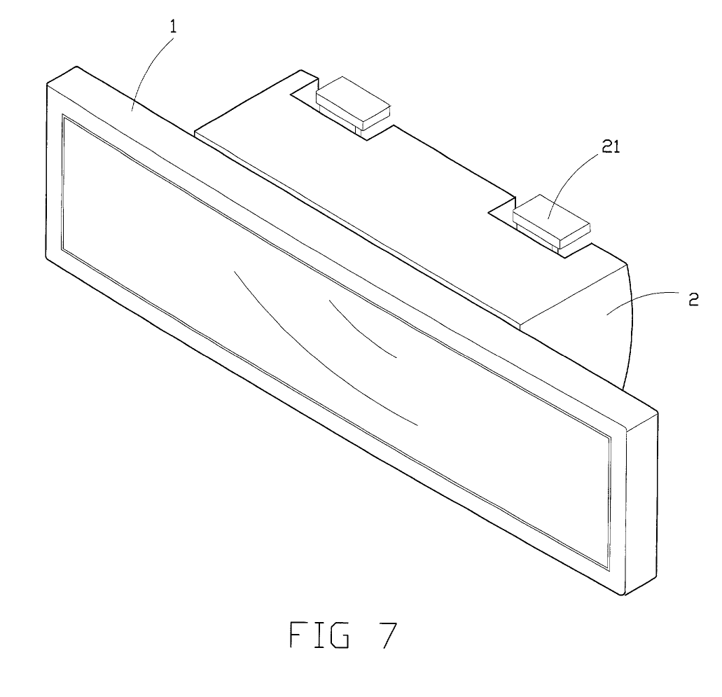

Please refer to FIGS. 1 and 7 that are exploded and assembled perspective views, respectively, of a wide-angle rearview mirror frame 1 according to an embodiment of the present invention. As shown, the wide-angle rearview mirror frame 1 includes a storage box 2 pivotally connected at a lower front edge to a lower rear edge of the wide-angle rearview mirror frame 1.

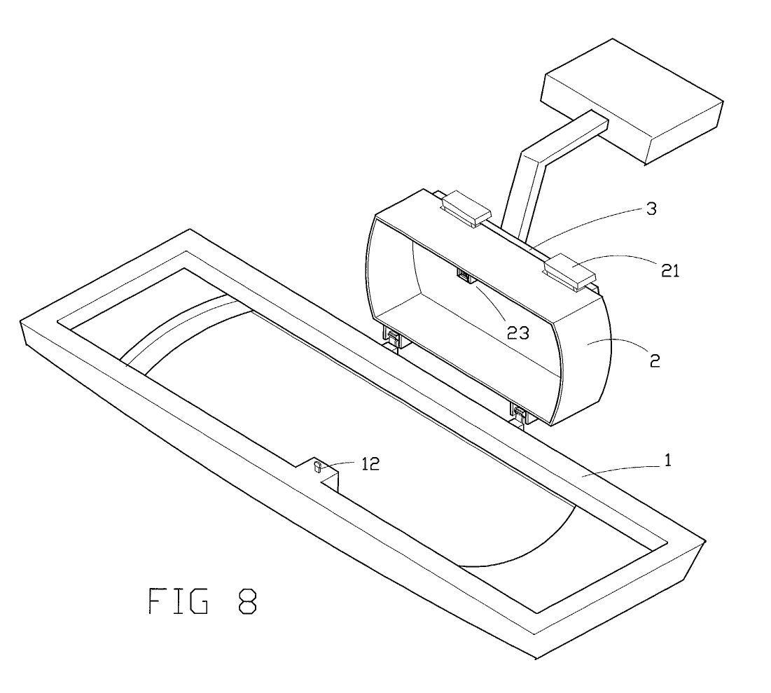

The storage box 2 is not limited to any specific size and shape. In the illustrate embodiment, the storage box 2 has a back wall, four side walls, and a front opening that faces toward a rear side of the wide-angle rearview mirror frame 1. The storage box 2 is provided near two upper rear corners with two elastic clamping claws 21, which are structurally similar to elastic clamping claws generally provided at an upper rear edge of a vehicle wide-angle rearview mirror frame for clamping onto a mounting plate 3 of the rearview mirror frame 1, as shown in FIG. 8.

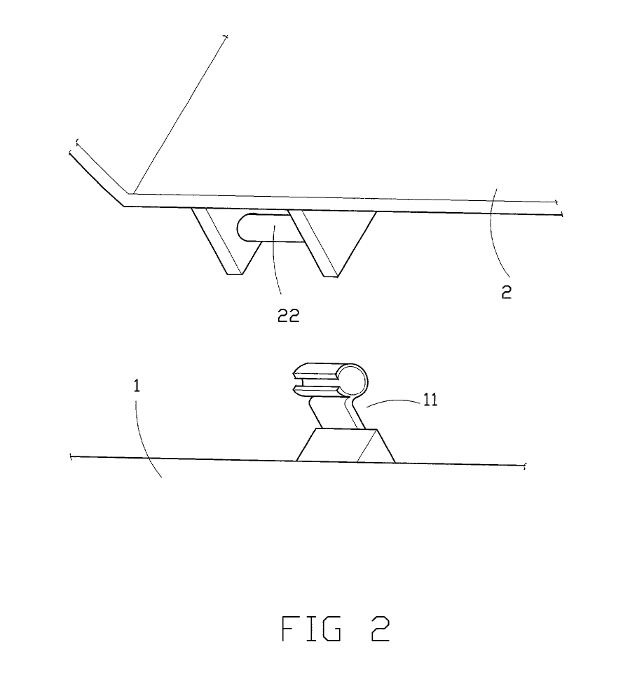

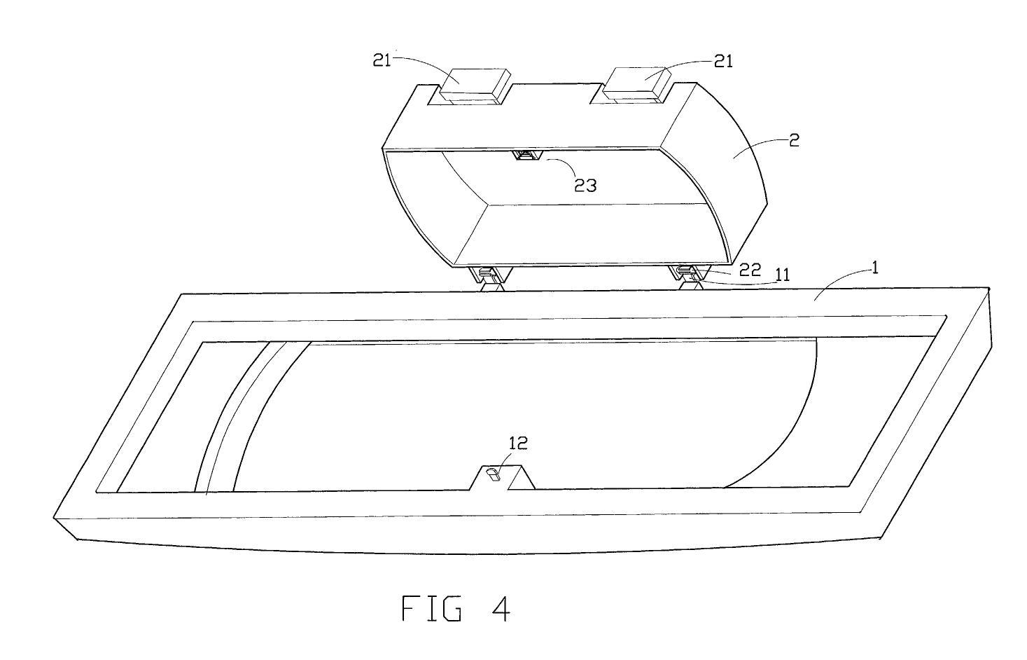

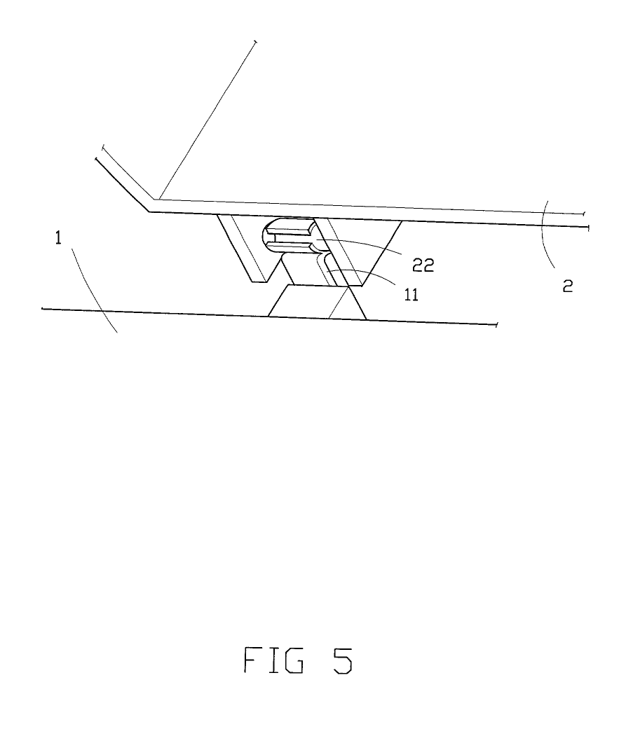

Please refer to FIGS. 1, 2, 4 and 5. The storage box 2 is also provided near two lower front corners with two pivot pins 22, and the wide-angle rearview mirror frame 1 is provided at a lower rear edge with two spaced knuckles 11 corresponding to the two pivot pins 22, so that the knuckles 11 are engaged with the pivot pins 22 to provide two hinge joints between the wide-angle rearview mirror frame 1 and the storage box 2.

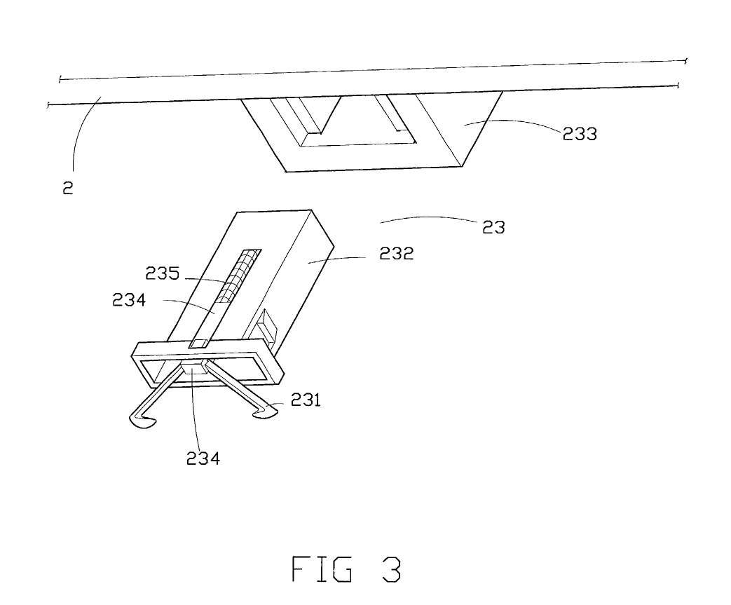

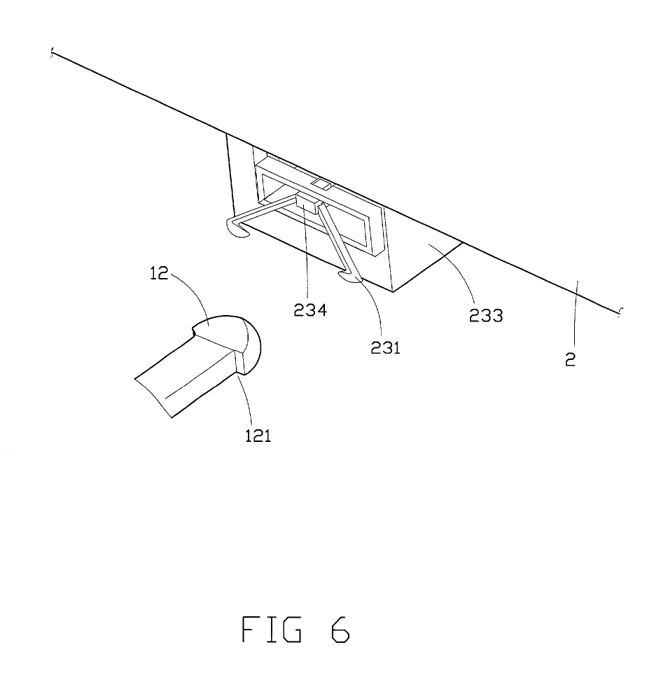

Please refer to FIGS. 1, 3, 4 and 6. The storage box 2 is further provided at an inner middle point of an upper edge of its front opening with a socket side 23 of a box fastener. As can be clearly seen from FIG. 3, the socket side 23 of the box fastener includes a pair of elastic claw hooks 231 having rear ends fixed to two sides of a shaft 234, a case 232 into which a compression spring 235 and the shaft 234 with claw hooks 231 are sequentially mounted, and a socket 233 fixedly connected to the inner middle point of the upper edge of the front opening to receive the case 232 therein. The compression spring 235 normally pushes the shaft 234 outward to expose the two claw hooks 231 from the case 232, and allows the shaft 234 and the claw hooks 231 to move into the case 232 under a force axially applied on the shaft 234. The wide-angle rearview mirror frame 1 is provided at an inner middle point of an upper rear edge with a fastening stud 12 corresponding to the socket side 23 of the box fastener. As can be clearly seen from FIG. 6, the fastening stud 12 includes two shoulder portions 121 behind a head portion thereof. When the head portion of the fastening stud 12 is moved toward the shaft 234 and pushes the latter into the case 232, the two claw hooks 231 are caused to pivotally turn toward each other and catch the fastening stud 12 by the shoulder portions 121, firmly holding the fastening stud 12 to the socket side 23 of the box fastener.

The wide-angle rearview mirror frame 1 may be pulled forward with a minor force to disengage the fastening stud 12 from the socket side 23 and open the storage box 2 for positioning things thereinto or removing things therefrom, and be pushed rearward to engage the fastening stud 12 into the socket side 23 to close the storage box 2.

With the storage box 2 connected to a rear side of the wide-angle rearview mirror frame 1, miscellaneous items, such as spectacles, mobile phones, facial tissues, and commutation tickets, may be conveniently positioned in the storage box 2 for easy access of these items.

It is to be understood the above-mentioned hinge joints formed from the knuckles 11 and the pivot pins 22, and the box fastener formed from the fastening stud 12 and the socket side 23 are only examples for implementing the present invention. Any other functionally equivalent designs could also be employed to connect and lock the storage box 2 to the wide-angle rearview mirror frame 1.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A vehicle wide-angle rearview mirror frame with storage box, comprising a wide-angle rearview mirror frame and a storage box pivotally connected to a rear side of said rearview mirror frame; said storage box including a closed casing with a front opening to define a receiving space having a predetermined depth; said storage box being pivotally connected at lower front edge to a lower rear edge of said wide-angle rearview mirror frame via hinge joints; and said storage box being detachably locked to the rear side of said wide-angle rearview mirror frame via a box fastener that includes a socket side fixedly mounted at a middle point of an upper front edge of said front opening of said storage box and a fastening stud fixedly mounted at a middle point of an upper rear edge of said rearview mirror frame and adapted to insert into said socket side to detachably engage with said socket side.
